(19) United States
(12) Patent Application Publication
(10) Pub. No.: US 2019/0092085 A1
(43) Pub. Date: Mar. 28, 2019

(54) WRITING UTENSIL WITH TELESCOPING CAP

(71) Applicant: DARBI MICHEL BODIE, THOUSAND OAKS, CA (US)

(72) Inventor: DARBI MICHEL BODIE, THOUSAND OAKS, CA (US)

(21) Appl. No.: 16/135,542

(22) Filed: Sep. 19, 2018

Related U.S. Application Data
(60) Provisional application No. 62/562,914, filed on Sep. 25, 2017.

(51) Int. Cl. B43K 24/04; A45D 40/20

(52) U.S. Cl. CPC B43K 24/04; A45D 2040/207; A45D 40/205

(57) ABSTRACT

A writing utensil with telescopic cap is provided including an elongate cylindrical writing utensil and telescopic cap. The writing utensil is preferably a makeup pencil having a traditional construction including a proximal end and a distal end having a writing tip. The telescoping cap includes a plurality of tubular elements that are concentric and slide telescopically relative to one another. The tubular elements include an innermost tubular element that has a closed end, and an outermost tubular element having an open end. The outermost tubular element has an interior sized diameter for receiving the writing utensil in a pressed-fit manner.

### RELATED APPLICATION

This application claims priority to U.S. Provisional Patent Application Ser. No. 62/562,914 filed on Sep. 25, 2017.

### BACKGROUND OF THE INVENTION

The present invention relates generally to writing utensils. More specifically, the present invention relates to writing utensils that can be extended and retracted.

Various writing utensils have been created for writing, ranging from pencils to different types of pens. Each utensil is designed with a similar purpose in mind; however, they accomplish each task differently. Some writing utensils are based on ink, others use graphite inserts depending on the application. As an example, utensils designed for drawing are different when compared to writing tools.

The makeup industry for example, has numerous pencils that allow users to apply certain contours. There is a wide selection available, and traditionally they comprise a wooden body, with a pigmented inner core. For skincare applications, the pencil is designed to hide certain imperfections or highlight facial features. As the core wears out, the wooden body of the pencil may be honed using a sharpener. The sharpener removes excess material from the body revealing a sharp tip. The thin end of the pencil, allows for precise application. These types of pencils are versatile and especially useful in masking blemishes, or emphasizing contours. However, depending on the type of materials used in the core, the cost of these products can be very high. Therefore, maximizing their usage is critical.

There are many times when it would be advantageous to provide a writing utensil which has a body that can be extended for ease of use. For example, at times it is desirable to have a writing utensil which is small and compact for storage, but has an extendable structure for facilitating use by one's hand. In addition, once a pencil is sharpened excessively by the removal of the wooden body of the pencil, it becomes difficult to hold as the surface area of the grip diminishes.

Various pens and pencils have been developed which have an extendable body and a separate cap. For example, U.S. Pat. No. 2,144,006 describes a pencil and a cap wherein the cap can be mounted upon the proximal end of the pencil so as to extend its length. Meanwhile, U.S. Pat. No. 2,518,128 provides a telescoping pen or pencil which includes a plurality of telescoping segments which can extend and retract to adjust the length of the pen or pencil's body. Similarly, a telescoping pencil is described in U.S. Pat. No. 2,571,830, and a telescoping ball point pen is described in U.S. Pat. No. 6,474,889.

Unfortunately, all of these extendable pens and pencils suffer from various drawbacks. For example, previous telescoping pencils do not allow one to incorporate traditional pencil constructions or allow one to replace the pencil.

Thus, it would be desirable to provide an assembly which is capable of utilizing existing pencils or pens.

Moreover, it would be desirable to provide an assembly which has a reduced diameter compared to prior extendable and retractable writing utensils.

### SUMMARY OF THE INVENTION

The present invention is directed to a writing utensil with a telescopic cap. The writing utensil may be of any kind such as a traditional pen or pencil. Moreover, the invention is believed to have particularly useful application for use with makeup pencils such as an eyebrow pencil. The writing utensil has a traditional construction including a substantially cylindrical barrel having a proximal end and a distal end. The distal end includes a writing tip which can take various forms known to those skilled in the art. For example, the writing tip may include the sharpened end of a pencil, or an assembly for dispensing ink such as a ball-point construction. Meanwhile, the writing utensil's proximal end may be devoid of any structure that is found at the back end of a pen or pencil. Alternatively, the writing utensil's proximal end may include features such as a pencil eraser or an openable and closeable cavity for holding pencil lead. Importantly, both the proximal end and distal end of the cylindrical writing utensil have a diameter which is substantially the same.

A cap is provided for covering the writing utensil's writing tip. The cap is telescopic and includes a plurality of concentric tubular elements that telescopically slide relative to one another. The telescopic cap may include any number of concentric tubular elements, but must include at least an innermost tubular element and an outermost tubular element which slide telescopically relative to one another. In a preferred embodiment, the telescopic cap includes three tubular elements including an innermost tubular element, an intermediate tubular element, and an outermost tubular element.

The innermost tubular element has a closed end and defines the proximal end of the telescopic cap. Conversely, the tubular cap's outermost tubular element has an open end and defines the distal end of the telescopic cap. The interior diameter of the outermost tubular element has a diameter substantially the same as the diameter of the writing utensil's proximal end and distal end so as to accept either end of the writing utensil in a pressed-fit arrangement.

In use, the telescopic cap is extendable with each of the tubular elements extending relative to one another, or retractable wherein each of the tubular elements retract concentrically within one another. Either end of the writing utensil can be positioned within the telescopic cap's open end. For example, when not in use, the telescopic cap is placed in a retracted condition and the writing utensil's distal end, including its writing tip, is positioned within the telescopic cap's open end so as to provide a compact construction for storage. Alternatively, the telescopic cap can be extended to an extended condition and the writing utensil's proximal end can be positioned with the telescopic cap's open end so as to provide a writing instrument having an elongated handle so as to facilitate its manipulation.

Thus, it is an object of the present invention to provide a telescopic cap for a writing utensil having a reduced diameter for storage. It is still an additional object of the invention to provide a telescopic cap which is suitable for use with replacement pens or pencils.

These and other specific objects and advantages of the invention will be apparent to those skilled in the art from the following detailed descriptions taken in conjunction with the drawings.

### BRIEF DESCRIPTION OF THE DRAWINGS

FIG. 1. is a front perspective view of a writing utensil with telescopic cap of the present invention;

FIG. 2 is a rear perspective view of the writing utensil with telescopic cap of the present invention;

FIG. 3 is an exploded perspective view of the writing utensil with telescopic cap of the present invention;

FIG. 4 is side cutaway view of the writing utensil with telescopic cap wherein the telescopic cap is in a retracted condition;

FIG. 5 is side cutaway view of the writing utensil with telescopic cap wherein the telescopic cap is in an extended condition; and

FIG. 6 is a perspective view illustrating the writing utensil with telescoping cap in use to apply makeup.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

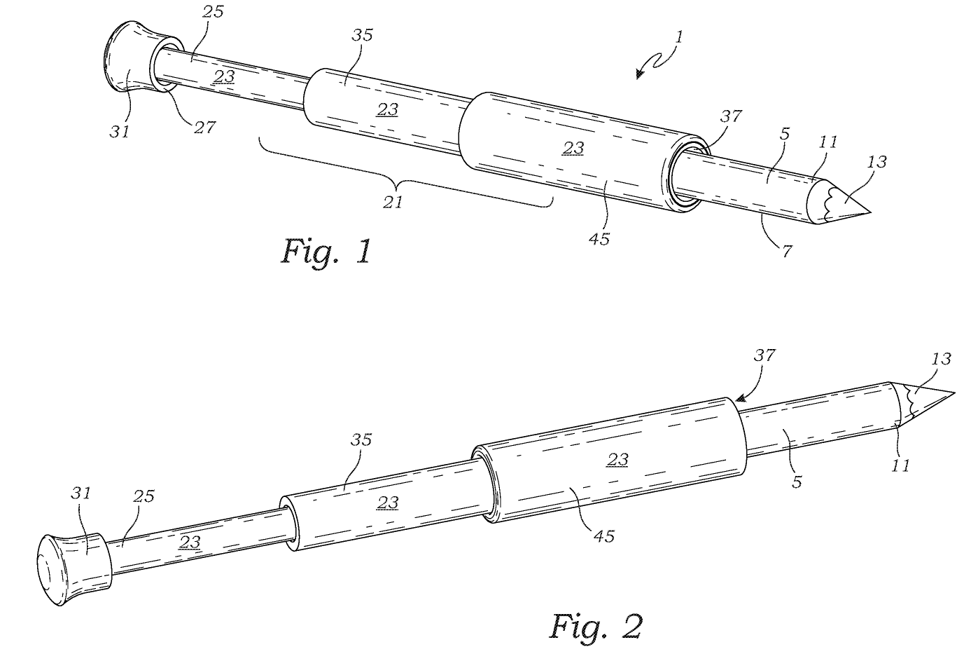

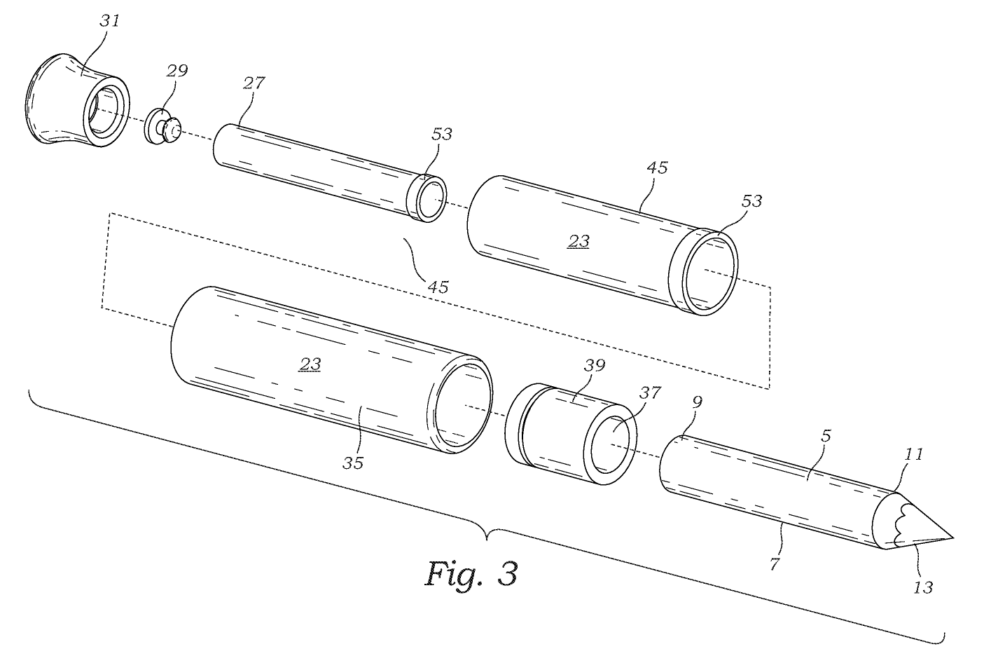

With reference to FIGS. 1-6, the writing utensil and telescopic cap 1 of the present invention includes two primary components, namely a writing utensil 5 and a telescopic cap 21. Preferably, the writing utensil 5 has a relatively traditional construction including an elongate cylindrical body 7 which terminates at its distal end 11 with a writing tip 13. The writing utensil's proximal end 9 may include various features such as an eraser or a second writing tip.

However, in a preferred embodiment, the writing utensil's proximal 9 end is featureless. The writing utensil 5 may be of any type known to those skilled in the art including a wooden pencil, mechanical pencil, or ink-filled pen. However, in the preferred embodiments illustrated in the figures the writing utensil 5 is a makeup pencil.

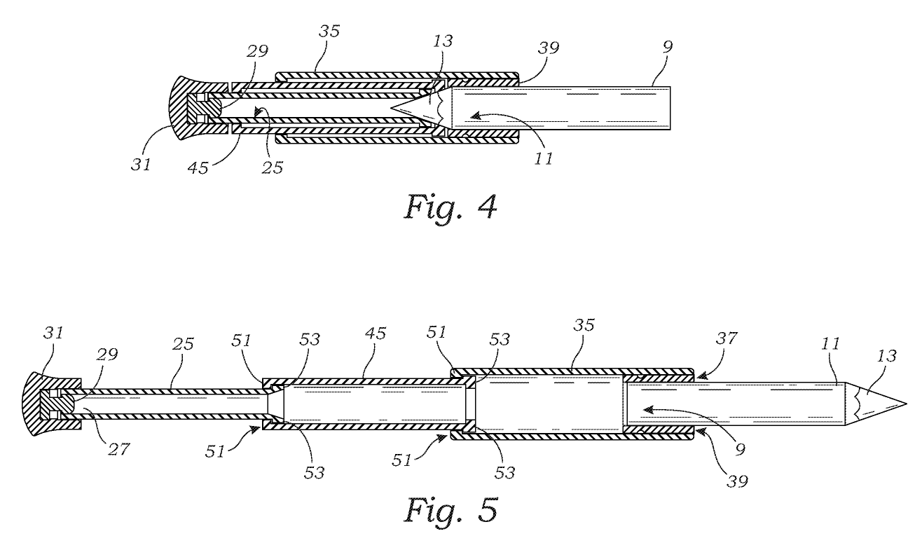

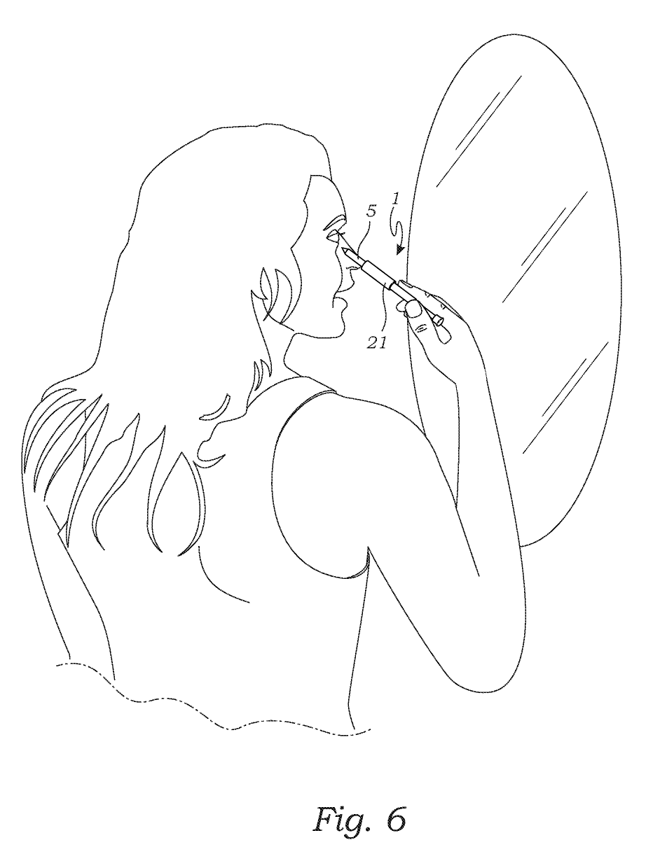

Meanwhile, with reference primarily to FIGS. 1-5 the telescopic cap 21 includes a plurality of tubular elements 23. The telescopic cap 21 may include any number of tubular elements 23 greater than two. However, in the preferred embodiment illustrated in the Figures, the telescopic cap 21 includes three tubular elements 23 including an innermost tubular element 25, an intermediate tubular element 45, and an outermost tubular element 35. The tubular elements 23 are concentric to one another and telescopically slidable relative to one another from an extended condition (see FIG. 5) to a retracted condition (see FIG. 4), and vise versa.

The innermost tubular element 25 has a closed end 27 which defines the proximal end of the telescopic cap 1. Conversely, the tubular cap's outermost tubular element 35 has an open end 37 which defines the distal end of the telescopic cap 21. With reference to FIG. 5, preferably the distal end of the innermost tubular element 25, has an outwardly extending flange 53 and the intermediate tubular element 45 has an inwardly extending flange 51 at its proximal end so as to prevent the interior tubular element 25 from inadvertently disengaging from the intermediate tubular element 45. Similarly, preferably the distal end of the intermediate tubular element 45 has an outwardly extending flange 53 for engaging the outermost tubular element's inwardly extending flange 51 so as to prevent inadvertent disengagement of the intermediate tubular element 45 from the outermost tubular element 35.

As best illustrated in FIGS. 3-5, preferably the proximal end of the innermost tubular element 25 is closed by a plug 29 and knob 31. In a preferred embodiment, the plug 29 is made of plastic of a color that identifies the features of the writing utensil 5, and the knob 31 is made of a clear plastic so that the color of the plug 29 can be seen by the user of the utensil. For example, in a preferred embodiment, the writing utensil 5 is a makeup pencil having a pigment color which matches the color of the plug 29 which can be seen by the user through the clear material of the knob 31.

The writing utensil 5 is intended to be affixed into a pressed-fit engagement within the open end 37 of the outermost tubular element 35. Since either end of the writing utensil 5 is intended to be positioned within the telescopic cap's open end 37, the writing utensil's proximal end 9 has the same shape and diameter as the writing utensil's distal end 11. As illustrated in FIG. 4, it is preferred that the writing utensil's distal end 11 and its corresponding writing tip 13 be located in the telescopic cap's open end 37 when the writing utensil end is not in use, and the telescoping cap is slid to a retracted condition. Conversely, it is preferred that the writing utensil be removed from a telescopic cap's open end 37, and then the writing utensil's proximal end 9 is reinserted into the telescopic cap's open end 37 when the writing utensil is intended to be used. Advantageously, the telescopic cap 21 can be extended to and extended condition for use, as illustrated in FIG. 6.

The telescopic cap 21, may or may not, incorporate an adapter collar 39. As illustrated in FIGS. 3-5, in a preferred embodiment, the outermost tubular element 5 includes a removable cylindrical collar 39 which has an outer diameter and inner diameter. Advantageously, the telescopic cap can be provided with a plurality of cylindrical collars 39 having the same outer diameter but different inner diameters to accept writing utensils of different diameters.

While several particular forms of the invention have been illustrated and described, it would be apparent that various modifications can be made without departing from the spirit and scope of the invention. Accordingly, it is not intended that the invention be limited by the following claims.

1. A writing utensil with telescopic cap comprising:
an elongate substantially cylindrical writing utensil including a proximal end and a distal end, said proximal end having substantially the same diameter as said distal end, and said distal end including a writing tip;
a telescopic cap for capping said writing utensil's writing tip, said telescopic cap including a plurality of concentric tubular elements that telescopically slide relative to one another from an extended condition to a retracted condition and vice versa, said tubular elements having an innermost tubular element that has a closed end defining the proximal end of the telescopic cap, and said tubular elements having an outermost tubular element that has an open end defining the distal end of the telescopic cap, said outermost tubular element's open end having an inner diameter substantially the same as the diameter of said writing utensil's proximal end and distal end; and
said writing utensil's proximal and distal ends disengageable or engageable in a press-fit manner into said cap's outermost tubular element's open end so that said writing utensil's distal end can be inserted into said cap's outermost tubular element's open end to cap said writing utensil's writing tip, and so that said writing utensil's proximal end can be inserted into said cap's outermost tubular element's open end with said telescopic cap extended to an extended condition to provide an elongated writing instrument.

2. The writing utensil with telescopic cap of claim 1 wherein said writing utensil is a makeup pencil.

3. The writing utensil with telescopic cap of claim 1 wherein said writing utensil is an eyebrow pencil

4. The writing utensil with telescopic cap of claim 1 wherein said innermost tubular element's closed end includes a knob.

5. The writing utensil with telescopic cap of claim 4 wherein writing utensil writes in a color that matches the color of said knob.

6. The writing utensil with telescopic cap of claim 1 wherein said tubular cap includes three tubular elements including said innermost tubular element, an intermediate tubular element, and said outermost tubular element.
